(19) United States
(12) Patent Application Publication
(10) Pub. No.: US 2026/0316349 A1
(43) Pub. Date: Oct. 15, 2026

(54) TOUGH AND MOLDABLE BIODEGRADABLE POLYMER COMPOSITIONS AND THE METHOD OF MAKING THEREOF

(71) Applicant: Erthos Inc., Mississauga (CA)

(72) Inventors: Nima ZARRINBAKHSH, Mississauga (CA); Xiuzheng WANG, Mississauga (CA)

(21) Appl. No.: 19/631,057

(22) Filed: Mar. 27, 2026

Related U.S. Application Data
(60) Provisional application No. 63/786,002, filed on Apr. 9, 2025.

(51) Int. Cl. B29C 45/00; B29C 45/37; B29K 67/00; C08G 63/08; C08K 3/013; C08K 3/26; C08K 5/00; C08L 67/00

(52) U.S. Cl. CPC B29C 45/0001; B29C 45/37; C08G 63/08; C08K 3/013; C08K 3/26; C08K 5/0016; C08L 67/00; B29K 2067/00; B29K 2995/006; B29K 2995/0077; B29K 2995/0089; C08G 2230/00; C08K 2003/265; C08L 2201/06; C08L 2205/02

(57) ABSTRACT

The invention relates to tough and moldable biodegradable polymer compositions with high impact resistance, elongation, and mechanical strength. The compositions comprise biodegradable thermoplastic polymers, biobased plasticizers, inorganic fillers, organic acids and optionally other additives. The compositions exhibit an excellent balance between elongation-at-break greater, tensile strength, impact strength, rigidity, and melt flow index while maintaining full biodegradability within 180 to 365 days. The biodegradable resins can be produced using traditional polymer processing equipment such as twin screw extruders or batch mixers. The resins can be formed into rigid parts and end products using traditional techniques including injection molding, thin-walled injection molding, compression molding and thermoforming.

### CROSS-REFERENCE TO RELATED APPLICATION

This application claims priority from U.S. Provisional Application Ser. No. 63/786,002, filed Apr. 9, 2025, the disclosure of which is incorporated by reference herein in its entirety.

### FIELD OF INVENTION

The invention encompasses the development of biodegradable thermoplastic resin compositions with a wide range of melt flow index (MFI), different biobased content and great mechanical properties, especially elongation at break and impact resistance. The invention further encompasses the production of resin via polymer processing techniques, such as but not limited to, twin screw extrusion or batch mixers as well as use of the resin in rigid applications using techniques including but not limited to injection molding, compression molding, and thermoforming.

### BACKGROUND OF THE INVENTION

The increasing reliance on single-use plastics has led to a significant global plastic waste crisis. Traditional petroleum-based plastics persist in the environment for hundreds of years, accumulating in landfills, oceans, and natural ecosystems.

Plastic pollution not only threatens marine and wildlife but also introduces microplastics into the food chain, raising concerns about human health. Despite recycling efforts, a large proportion of plastic waste still ends up in landfills or is incinerated, contributing to greenhouse gas emissions and environmental degradation.

A sustainable alternative to conventional plastics is the development of compostable resins, which break down into carbon dioxide, water vapor and non-toxic organic matter under controlled composting conditions. Unlike traditional plastics, which persist indefinitely, compostable polymers degrade within months, significantly reducing long-term environmental impact.

These resins are particularly beneficial in food packaging, agricultural films, and disposable consumer products, where short-term use and quick degradation are desirable. However, despite their advantages, compostable resins face significant limitations in processing and mechanical performance, particularly in injection molding applications.

Injection molding is one of the most widely used manufacturing techniques for producing high-precision, complex-shaped plastic components. However, compostable resins pose significant challenges in this process, particularly in thin-walled injection-molded parts that require excellent flowability and cavity-filling capabilities.

Among compostable resins, polylactic acid (PLA) and polyhydroxyalkanoates (PHAs) have good melt flow but are too brittle, while polybutylene adipate terephthalate (PBAT) is flexible but lacks strength and melt flow, and polybutylene succinate (PBS) has moderate mechanical properties but is too soft for structural applications and is limited in melt flow for many complicated injected parts.

Blending of bioplastics is a method to obtain a resin with balanced mechanical properties and melt flow of the different moieties. However, when PLA and PHAs are blended with PBAT or PBS to improve toughness and reduce brittleness, the resulting resin exhibits a significant decrease in melt flow and strength compared to neat polymer. That is because the improvement in elongation at break and impact resistance is only achieved at high concentrations of the soft bioplastics in the blend therefore making it more difficult to process in injection molding applications, particularly for thin-walled parts.

To address the environmental concerns over plastic pollution using the high potential that compostable resins offer, it is therefore necessary to develop formulations out of compostable bioplastics that demonstrate high melt flow and mechanical properties while the compostability and biodegradability of the resin is not adversely affected.

### SUMMARY OF THE INVENTION

This summary offers a simplified introduction to several concepts, which are further explained in detail below. It does not aim to highlight key or essential features of the claimed subject matter and should not be used to determine its scope.

The biodegradable thermoplastic resin compositions of the invention can be used to produce rigid parts for single use and durable applications in industries, such as but not limited to, consumer goods and packaging, agriculture and horticulture, food and beverage, medical and healthcare, etc.

The biodegradable thermoplastic resin compositions of this invention exhibit a broad melt flow index range, from low and moderate to high and very high. This versatility makes the resins suitable for injection-molded parts with varying complexity and wall thickness.

The biodegradable thermoplastic resin compositions of this invention demonstrate enhanced elongation at break and impact resistance compared to neat polymer while the strength and rigidity is maintained within an acceptable range for many rigid applications.

In certain embodiments, production methods for biodegradable thermoplastic resins via melt compounding at specific weight ratios are provided.

In various embodiments, the biodegradable resin composition comprises about 35 to about 90% (w/w) of one or more biodegradable thermoplastic polymers, about 1 to about 12% (w/w) of one or more plasticizers, about 3 to about 30% (w/w) of one or more first inorganic fillers, about 3 to about 25% (w/w) of a one or more second inorganic fillers, about 0.01 to about 5% (w/w) of one or more organic acids, and about 0 to about 10% (w/w) of one or more of additives including but not limited to compatibilizers, biomass, impact modifiers, nucleating agents, processing aids, chain extenders, initiators, peroxides, and pigments.

### DETAILED DESCRIPTION OF THE INVENTION

To facilitate an understanding of the invention, it will be described more comprehensively herein below. However, the invention may be embodied in different forms and is not limited to the embodiments set forth herein. Rather, these embodiments are provided for the purpose of making the disclosure of the invention more thorough and comprehensive.

Unless otherwise defined, all technical and scientific terms used herein have the same meaning as those commonly understood by a person skilled in the art to which the present invention belongs. Terms used in the specification of the present invention are only for the purpose of describing specific embodiments, and are not intended to limit the present invention.

### Definitions

As used herein, “additive” could refer to material used to enhance a targeted property or function of material and/or composition, which could be in any form such as solid, liquid, powder, fiber, or crystal.

The prefix “bio” as used herein refers to a material that has been derived from a renewable biological resource.

The term “biobased” or “bio-based” refers to compositions that are derived from plant matter instead of being made from petroleum or natural gas. Because these are plant-based, there is a tendency to assume that the additive must be biodegradable. However, this is not the case for all plant-based compositions. The bio-based compositions of the invention can be designed to biodegrade in less than 6 months.

The term “biodegradable” refers to compositions of the invention that can biodegrade within 12 months in a compost environment in a non-toxic, environmentally compatible manner with no heavy metal nor PTFE content, and remaining soil-safe (i.e., lack of eco-toxins). The hydrophobic compositions of the invention biodegrade within 12 months. Compostable materials are biodegradable, but not every biodegradable material is compostable. The hydrophobic compositions of the invention are well known to be biodegradable. As used herein, “biodegradable” compositions are engineered to biodegrade in compost, soil, or water.

The term “bioplastics” or “biopolymer” is used to refer to plastics that are bio-based, biodegradable, or fit both criteria. Bio-based plastics of the invention are fully or partly made from renewable feedstock derived from biomass. Commonly used raw materials to produce these renewable feedstock for plastic production include, but are not limited to, corn starch, corn stalks, sugarcane stems, cellulose, and various oils and fats from renewable sources.

The term “compostable” compositions refer to biodegradation into soil conditioning material (i.e., compost). In order for a plastic to be labeled as commercially “compostable” it should be broken down by biological treatment at an industrial composting facility in 180 days or less. Composting utilizes microorganisms, agitation, heat, and humidity to yield carbon dioxide, water, inorganic compounds, and biomass that is similar in characteristic to the rest of the finished compost product. Decomposition of the composition should occur at a rate similar to the other elements of the material being composted (e.g., within 6 months) and leave no toxic residue that would adversely impact the ability of the finished compost to support plant growth. ASTM Standards D6400 and D6868 outline the specifications that must be met in order to label a plastic as “industrial compostable”.

The term “disintegration” refers to a plastic product that leaves no more than 10% of its original dry weight after twelve weeks (84 days) in a controlled thermophilic composting test and sieved through a 2.0-mm mesh.

The term “polymers” refers to polymers of the invention that are obtained, for example, by aliphatic diols, aliphatic dicarboxylic acids, and aromatic dicarboxylic acids/esters. The term polymers also includes aliphatic-aromatic polymers. The biodegradable thermoplastic polymers of the current invention include but are not limited to: polylactic acid (PLA) or poly(lactic acid) (PLA); polycaprolactone (PCL); poly(butylene succinate) (PBS) or polybutylene succinate (PBS); polyglycolic acid (PGA) or poly(glycolic acid) (PGA); poly(butylene succinate adipate) (PBSA), polybutylene succinate adipate (PBSA), poly(butylene succinate-co-adipate) (PBSA), polybutylene succinate-co-adipate (PBSA), poly(butylene succinate-co-butylene adipate) (PBSA) or polybutylene succinate-co-butylene adipate (PBSA); poly(butylene succinate terephthalate) (PBST), polybutylene succinate terephthalate (PBST), poly(butylene succinate-co-terephthalate) (PBST), polybutylene succinate-co-terephthalate (PBST), poly(butylene succinate-co-butylene terephthalate) (PBST) or polybutylene succinate-co-butylene terephthalate (PBST); poly(butylene adipate terephthalate) (PBAT), polybutylene adipate terephthalate (PBAT), poly(butylene adipate-co-terephthalate) (PBAT), polybutylene adipate-co-terephthalate (PBAT), poly(butylene adipate-co-butylene terephthalate) (PBAT) or polybutylene adipate-co-butylene terephthalate (PBAT); and polyhydroxyalkanoates (PHAs).

The term polyhydroxyalkanoates (PHAs) refers to a family of bio-based thermoplastic polymers synthesized by various microorganisms, particularly through bacterial fermentation. The PHA family encompasses over 150 different monomers, allowing for the production of materials with a wide range of properties. Notably, these plastics are biodegradable and include, but are not limited to, poly-3-hydroxybutyrate (PHB), polyhydroxybutyrate-co-hydroxyvalerate (PHBV), poly-4-hydroxybutyrate (P4HB), polyhydroxybutyrate-co-hydroxyhexanoate (PHBH), polyhydroxyvalerate (PHV), polyhydroxyhexanoate (PHH), polyhydroxyoctanoate (PHO), polyhydroxydecanoate (PHD), and polyhydroxydodecanoate (PHDD).

The terms “resin” and “blend” as used herein interchangeably, refer to a homogeneous mixture of two or more different polymers and elastomers along with other ingredients.

The term “thin-walled injection molding” refers to the injection molding of parts in which the wall thickness is small relative to the flow length, typically characterized by a flow length-to-thickness ratio (L/t) of more than 150, and where the wall thickness is generally less than 2 mm for most injection molded application, and less than 1 mm particularly for many packaging applications.

As used herein, “wt. %”, “parts by mass (w/w)” or “parts by mass % (w/w)” refer to the percentage weight of an ingredient with respect to the total weight of a composition.

### Composition of the Biodegradable Thermoplastic Resin

In various embodiments, the invention encompasses biodegradable thermoplastic polymers. The biodegradable thermoplastic polymers of the invention comprise biodegradable thermoplastic polyesters including, but not limited to, at least one or more of polylactic acid (PLA), polyglycolic acid (PGA), polycaprolactone (PCL), polybutylene succinate (PBS), polybutylene succinate adipate (PBSA), polybutylene succinate terephthalate (PBST), polybutylene adipate-co-terephthalate (PBAT), polyhydroxyalkanoates (PHAs), other biodegradable polymers, and a combination thereof.

The parts by mass (w/w) of the biodegradable thermoplastic polymer in the biodegradable resin composition are about 35 to 90 wt. %. In various embodiments, the parts by mass (w/w) of biodegradable thermoplastic polymers in the resin are about 35, 40, 50, 60, 70, 80, 85 and 90 wt. %.

The embodiment compositions may include, but are not limited to, any of the following polymer combinations:

In certain embodiments, the biodegradable thermoplastic polymers include polylactic acid and polycaprolactone.

In certain embodiments, the biodegradable thermoplastic polymers include polylactic acid and polybutylene succinate.

In certain embodiments, the biodegradable thermoplastic polymers include polylactic acid and polybutylene succinate adipate.

In certain embodiments, the biodegradable thermoplastic polymers include polylactic acid and polybutylene succinate terephthalate.

In certain embodiments, the biodegradable thermoplastic polymers include polylactic acid and polybutylene adipate terephthalate.

In certain embodiments, the biodegradable thermoplastic polymers include polylactic acid and polyhydroxyalkanoates.

In certain embodiments, the biodegradable thermoplastic polymers include polycaprolactone and polybutylene succinate.

In certain embodiments, the biodegradable thermoplastic polymers include polycaprolactone and polybutylene succinate adipate.

In certain embodiments, the biodegradable thermoplastic polymers include polycaprolactone and polybutylene succinate terephthalate.

In certain embodiments, the biodegradable thermoplastic polymers include polycaprolactone and polybutylene adipate terephthalate.

In certain embodiments, the biodegradable thermoplastic polymers include polycaprolactone and polyhydroxyalkanoates.

In certain embodiments, the biodegradable thermoplastic polymers include polybutylene succinate and polybutylene succinate adipate.

In certain embodiments, the biodegradable thermoplastic polymers include polybutylene succinate and polybutylene succinate terephthalate.

In certain embodiments, the biodegradable thermoplastic polymers include polybutylene succinate and polybutylene adipate terephthalate.

In certain embodiments, the biodegradable thermoplastic polymers include polybutylene succinate and polyhydroxyalkanoates.

In certain embodiments, the biodegradable thermoplastic polymers include polybutylene succinate adipate and polybutylene succinate terephthalate.

In certain embodiments, the biodegradable thermoplastic polymers include polybutylene succinate adipate and polybutylene adipate terephthalate.

In certain embodiments, the biodegradable thermoplastic polymers include polybutylene succinate adipate and polyhydroxyalkanoates.

In certain embodiments, the biodegradable thermoplastic polymers include polybutylene succinate terephthalate and polybutylene adipate terephthalate.

In certain embodiments, the biodegradable thermoplastic polymers include polybutylene succinate terephthalate and polyhydroxyalkanoates.

The abovementioned embodiments are not limited to binary combinations of biodegradable thermoplastic polymers, but could encompass combinations of three or more biodegradable thermoplastic polymers.

In one embodiment, the biodegradable resin composition further includes in parts by mass (w/w) of about 1 to about 12 of at least one plasticizer. In various embodiments, the amount of the plasticizer is about 1, 2, 3, 4, 5, 6, 7, 8, 9, 9.5, 10, 10.5, 11, 11.5, and 12 wt. %.

In various embodiments, the plasticizers include but are not limited to, plant-based oils obtained from sources such as vegetables, nuts, grains, seeds, etc. Examples of such oils include, but are not limited to, corn oil, soybean oil, linseed oil, and glycerol. These plant-based oils can be used either in their virgin or modified form (e.g., through epoxidation, carboxylation, hydroxylation, and amidation). Modified plant-based oils such as epoxidized vegetable oil, epoxidized soybean oil, epoxidized linseed oil, and a range of citrate oils (e.g., acetyl tributyl citrate (ATBC), triethyl citrate (TEC), acetyl triethyl citrate (ATEC), tributyl citrate (TBC)), as well as isosorbide-type oils, natural waxes, glycol, sugar alcohols (e.g. xylitol, sorbitol, lactitol, mannitol, erythritol, maltitol), isosorbide diester, and fatty acid methyl esters (FAME) are also encompassed.

In certain embodiments, the biodegradable blend composition further includes, in parts by mass (w/w) of about 3 to about 30% of one or more first inorganic fillers. In various embodiments, the amount of the first inorganic fillers is about 3, 4, 5, 6, 7, 8, 9, 10, 12.5, 15, 17.5, 20, 22.5, 25, 27.5, and 30 wt. %.

In certain embodiments, the biodegradable blend composition further includes, in parts by mass (w/w) of about 5 to about 25% of one or more second inorganic fillers. In various embodiments, the amount of the second inorganic fillers is about 5, 6, 7, 8, 9, 10, 12.5, 15, 17.5, 20, 22.5, 23, 23.5, 24, 24.5, and 25 wt. %.

In certain embodiments, the first inorganic fillers include, but are not limited to, wollastonite, mica, micro- and nano-clays, non-ionic clays, anionic clays, cationic clays, serpentinite, illite, kaolinite, pyrophyllite, vermiculite, chlorite, talc, sepiolite, aluminum silicate, vermiculites, bentonite, smectites (montmorillonite, nontronite and beidellite, and trioctahedral smectites, such as saponite), swelling micas, and a combination thereof, all in modified or unmodified form.

In certain embodiments, the second inorganic fillers include, but are not limited to, hydrotalcites, layered double hydroxides, unmodified or modified hydrotalcite, calcium carbonate, glass fiber, silicon dioxide, zirconium oxide, gypsum, and a combination thereof, all in modified or unmodified form.

In various embodiments, the aspect ratio of the inorganic filler is modified through physical and/or chemical techniques.

In various embodiments, the inorganic filler is treated through physical and/or chemical techniques to modify its surface functional groups, its physical form, or for other purposes.

In one embodiment, the biodegradable blend composition further includes, in parts by mass (w/w) of about 0.01 to about 5% of one or more organic acid including, but not limited to, monocarboxylic acids, dicarboxylic acids, tricarboxylic acids, hydroxy acids, and a combination thereof.

In one embodiment, the organic acid of the biodegradable blend composition encompasses monocarboxylic acids including, but not limited to, formic acid, acetic acid, propionic acid, butyric acid, valeric acid, caproic acid, enanthic acid, caprylic acid, pelargonic acid, capric acid, and a combination thereof.

In one embodiment, the organic acid of the biodegradable blend composition encompasses dicarboxylic acids including, but not limited to, oxalic acid, malonic acid, succinic acid, glutaric acid, adipic acid, pimelic acid, suberic acid, azelaic acid, sebacic acid, itaconic acid, fumaric acid, maleic acid, and a combination thereof.

In one embodiment, the organic acid of the biodegradable blend composition encompasses tricarboxylic acids including, but not limited to, citric acid, aconitic acid, isocitric acid, trimesic acid, and a combination thereof.

In one embodiment, the organic acid of the biodegradable blend composition encompasses hydroxy acids including, but not limited to, lactic acid, malic acid, tartaric acid, glycolic acid, 2-hydroxyglutaric acid, mandelic acid, 3-hydroxybutyric acid, salicylic acid, kojic acid, ascorbic acid, and a combination thereof.

In various embodiments, the amount of the organic acid is about 0.01, 0.05, 0.1, 0.2, 0.3, 0.4, 0.5. 0.6, 0.7, 0.8, 0.9, 1, 2, 3, 4, 4.5, 4.75, and 5 wt. %.

In one embodiment, the biodegradable blend composition further includes, in parts by mass (w/w) of about 0 to about 10% of one or more additives including but not limited to compatibilizers, biomass, impact modifiers, nucleating agents, processing aids, chain extenders, initiators, peroxides, and pigments

In various embodiments, the amount of the additives is about 0, 0.01, 0.05, 0.1, 0.2, 0.3, 0.4, 0.5. 0.6, 0.7, 0.8, 0.9, 1, 2, 3, 4, 5, 6, 6.5, 7, 7.5, 8, 8.5, 9, 9.5, 9.75, and 10 wt. %.

In one embodiment, the additive of the biodegradable blend composition includes one or more compatibilizer which encompasses both short and long-chain hydrocarbons with functional groups such as, but not limited to, epoxides, hydroxyls, anhydrides, silanes and citrates.

In one embodiment, the compatibilizer encompasses titanate, aluminate, γ-aminopropyltriethoxysilane, γ-(2,3)epoxy (propoxy)propyltrimethoxysilane, γ-methacryloxypropyltrimethoxysilane, maleic anhydride grafted biodegradable polymers, hydrolyzed biodegradable polymers, peroxides and a combination thereof.

In one embodiment, the biodegradable blend composition further includes, in parts by mass (w/w) of about 0 to about 10% of one or more additives including but not limited to compatibilizers, biomass, impact modifiers, nucleating agents, processing aids, chain extenders, initiators, peroxides, and pigments;

In certain embodiments, the additive of the biodegradable blend composition encompasses biomass including, but not limited to, distillers' grains, vinasse, vinegar residues, cellulose nanocrystals, wood fiber, virgin starch, modified starch including thermoplastic starch, agricultural fiber from straw, stalk, shive, hurd, bast, leaf, seed, fruit, and perennial grass, all in a non-continuous non-woven form including chopped pieces, particulates, dust or flour.

In certain embodiments, the composition exhibits a tensile strength of more than about 10 MPa.

In certain embodiments, the composition exhibits a tensile strength of more than about 20 MPa.

In certain embodiments, the composition exhibits a tensile strength of more than about 30 MPa.

In certain embodiments, the composition exhibits a tensile strength of more than about 40 MPa.

In certain embodiments, the composition exhibits a tensile modulus of more than about 1000 MPa.

In certain embodiments, the composition exhibits a tensile modulus of more than about 1500 MPa.

In certain embodiments, the composition exhibits a tensile modulus of more than about 2000 MPa.

In certain embodiments, the composition exhibits a tensile modulus of more than about 3000 MPa.

In certain embodiments, the composition exhibits a tensile modulus of more than about 5000 MPa.

In certain embodiments, the composition exhibits an elongation at break of more than about 10%.

In certain embodiments, the composition exhibits an elongation at break of more than about 25%.

In certain embodiments, the composition exhibits an elongation at break of more than about 50%.

In certain embodiments, the composition exhibits an elongation at break of more than about 100%.

In certain embodiments, the composition exhibits a notched Izod impact strength of more than about 30 J/m.

In certain embodiments, the composition exhibits a notched Izod impact strength of more than about 50 J/m.

In certain embodiments, the composition exhibits a notched Izod impact strength of more than about 75 J/m.

In certain embodiments, the composition exhibits a notched Izod impact strength of more than about 100 J/m.

In certain embodiments, the composition exhibits a notched Izod impact strength of more than about 150 J/m.

In certain embodiments, the composition exhibits a notched Izod impact strength of more than about 200 J/m.

In certain embodiments, the composition exhibits a melt flow index (MFI) of more than about 5 g/10 min.

In certain embodiments, the composition exhibits a melt flow index (MFI) of more than about 10 g/10 min.

In certain embodiments, the composition exhibits a melt flow index (MFI) of more than about 20 g/10 min.

In certain embodiments, the composition exhibits a melt flow index (MFI) of more than about 30 g/10 min.

In certain embodiments, the composition exhibits a melt flow index (MFI) of more than about 40 g/10 min.

In certain embodiments, the composition exhibits a melt flow index (MFI) of more than about 60 g/10 min.

In certain embodiments, the composition exhibits 10%, 20%, 30%, 40%. 50%. 60%, 70%. 80%, or 90% disintegration completion within about 180 days under mesophilic (ambient) temperature conditions.

In certain embodiments, the composition exhibits more than 90% disintegration in less than 30, 40, 50, 60, 70, 80, 90, 100, 110, 120, 130, 140, 150, 160, 170, 175, or 180 days under mesophilic (ambient) temperature conditions.

In certain embodiments, the composition exhibits more than 90% biodegradation in less than 30, 40, 50, 60, 70, 80, 90, 100, 110, 120, 130, 140, 150, 160, 170, 180, 200, 225, 250, 275, 300, 325, 340, 345, 350, or 356 days under mesophilic (ambient) temperature conditions.

In certain embodiments, the composition exhibits 10%, 20%, 30%, 40%. 50%. 60%, 70%. 80%, or 90% disintegration completion within about 180 days in soil under mesophilic (ambient) temperature conditions.

In certain embodiments, the composition exhibits more than 90% disintegration in less than 30, 40, 50, 60, 70, 80, 90, 100, 110, 120, 130, 140, 150, 160, 170, 175, or 180 days in soil under mesophilic (ambient) temperature conditions.

In certain embodiments, the composition exhibits more than 90% biodegradation in less than 30, 40, 50, 60, 70, 80, 90, 100, 110, 120, 130, 140, 150, 160, 170, 180, 200, 225, 250, 275, 300, 325, 340, 345, 350, or 356 days in soil under mesophilic (ambient) temperature conditions.

In certain embodiments, the composition exhibits 10%, 20%, 30%, 40%. 50%. 60%, 70%. 80%, or 90% disintegration completion within about 90 days under thermophilic (55-70 °C) temperature conditions.

In certain embodiments, the composition exhibits more than 90% disintegration in less than 30, 35, 40, 45, 50, 55, 60, 65, 70, 75, 80, 81, 82, 83, 84, 85, 86, 87, 88, 89, or 90 days under thermophilic (55-70 °C) temperature conditions.

In certain embodiments, the composition exhibits more than 90% biodegradation in less than 30, 40, 50, 60, 70, 80, 90, 100, 110, 120, 130, 140, 150, 160, 170, 175, or 180 days under thermophilic (55-70 °C) temperature conditions.

In certain embodiments, the final composition of the biodegradable resin exhibits more than 90% disintegration within 6 months under mesophilic (home composting) conditions and more than 90% disintegration within 12 weeks under thermophilic (industrial composting) conditions.

In certain embodiments, the final composition of the biodegradable resin exhibits more than 90% biodegradation within 365 days under mesophilic (home composting) conditions and more than 90% biodegradation within 6 months under thermophilic (industrial composting) conditions.

In certain embodiments, the final composition of the biodegradable resin is 100% compostable under home and/or industrial compostability conditions.

### Method of Production of the Biodegradable Resin Composition and the Subsequent Articles Thereof

The aforementioned ingredients may be processed together in various scenarios. In one embodiment, all ingredients are premixed and melt-processed together.

In another embodiment, the biodegradable thermoplastic polymer(s) is melted first, and then the rest of the ingredients are added to the system.

In another embodiment, the biodegradable thermoplastic polymer(s) is plasticized first, i.e. melt-processed with at least one plasticizer, and then the rest of the ingredients are added to the system.

In another embodiment, the biodegradable thermoplastic polymer(s) is melted first along with the inorganic filler(s), and then the other ingredients are added to the system.

In yet another embodiment, the biodegradable thermoplastic polymer(s) is melted first, and then the other additives are added to the system before the plasticizer(s) and the inorganic filler(s) are added.

The order of introducing the ingredients to the system is not limited to these embodiments and may include any other possible embodiments and combinations.

In one embodiment, the blending of the aforementioned ingredients may be achieved using mixing and melt-compounding equipment with adjustable and controllable temperatures, such as a single or twin screw extruder, or a batch mixer.

In a batch mixer, the processing temperature profile may range from 50 to 250 °C, and the processing time may be between 1 to 60 minutes.

Alternatively, in embodiments where single or twin screw extrusion is employed, the temperature profile may range from 50 to 250 °C, and the screw speed may range from 20 to 500 rpm.

It should be noted that the processing conditions provided herein are not limiting and may vary based on other conditions such as ingredient amounts and ratios and the type of processing equipment.

The resulting product may be pelletized and subsequently formed into desired rigid or flexible shapes and parts using conventional forming techniques including, but not limited to, injection molding, compression molding, thermoforming, film blowing, or cast film extrusion. The forming temperature is typically within the range used in the melt-processing and compounding of the resins and ingredients.

In other embodiments, the invention includes methods for preparing the biodegradable composition comprising the following steps; mixing uniformly and thoroughly all raw materials of the biodegradable composition at higher than ambient temperatures to prepare the biodegradable composition.

In other embodiments, the invention includes methods for preparing the biodegradable composition comprising the following steps; mixing uniformly and thoroughly, polymers at higher than ambient temperatures and then mixing uniformly and thoroughly with other raw materials of the biodegradable composition at higher than ambient temperatures to prepare the biodegradable composition.

In other embodiments, the invention includes methods for preparing the biodegradable composition comprising the following steps; mixing uniformly and thoroughly, specific groups or singular raw materials in certain order at higher than ambient temperatures to prepare the biodegradable composition.

In certain embodiments, the method further comprises forming any articles in any shape and rigidity using conventional polymer processing techniques such as thermoforming, hot press, vacuum forming, cast extrusion, film blowing, injection molding, blow molding, thin-walled injection molding, or compression molding.

In certain embodiments, the invention encompasses compositions and methods of making a disposable product, comprising the biodegradable composition of the invention, wherein the disposable products are packaging materials or consumer products.

### General Embodiments of the Invention

The present invention will now be explained in greater detail by means of the following examples.

Example 1: A biodegradable resin composition was produced via melt compounding in a 2-kg kneader batch mixer with rotating blades at about 38 rpm and preheated at about 220 °C. About 1400 g PLA was first added and melted in the kneader for 10-15 min followed by the addition of about 400 g mica and compounding for another 10 min before about 200 g vegetable-based oil was added and mixed thoroughly for about another 15 min. The composition was then extracted from the kneader once still melted. Once cooled, the composition was crushed into powder passing through a 5 mm mesh which was then injected into test bars using an injection molding machine. The same crushed powder was used for MFI measurement. The test bars were used to measure the mechanical properties according to ASTM protocols. The resulting resin exhibited a tensile strength of about 43 MPa, a tensile modulus of about 5450 MPa, an elongation at break of about 6%, a notched Izod impact strength of about 32 J/m and an MFI of about 82 g/10 min at 190 °C under a 2.16 kg load.

Example 2: A biodegradable resin composition was produced via melt compounding in a 2-kg kneader batch mixer with rotating blades at about 38 rpm and preheated at 200 °C. About 1200 g PLA was first added and melted in the kneader for about 10 min followed by the addition of about 2 g organic acid and mixing for about another 2 min. Then, about 40 g glycerol was added and mixed for about 3 min before about 300 g of impact modifier was added to the mixing kneader followed by the addition of about 400 g calcium carbonate and about 60 g agricultural fiber. The ingredients were thoroughly mixed in the kneader for a total mixing time of 25-28 min. The composition was then extracted from the kneader once still melted. Once cooled, the composition was crushed into powder passing through a 5 mm mesh which was then injected into test bars using an injection molding machine. The same crushed powder was used for MFI measurement. The test bars were used to measure the mechanical properties according to ASTM protocols. The resulting resin exhibited a tensile strength of about 29 MPa, a tensile modulus of about 2300 MPa, an elongation at break of about 2%, a notched Izod impact strength of about 44 J/m and an MFI of more than 120 g/10 min at 190 °C under a 2.16 kg load.

Example 3: A biodegradable resin composition was produced via melt compounding in a 2-kg kneader batch mixer with rotating blades at about 38 rpm and preheated at 225 °C. About 920 g PLA and 920 g PBAT were first added and melted in the kneader for about 10-15 min followed by the addition of about 80 g calcium carbonate and about 20 g talc at an rpm slower than the original setting. The mixture was mixed in the kneader for about another 3 min after which the rpm was increased to the original setting and about 60 g vegetable-based oil was added and mixed for about another 10 min. Finally, about 4 g agricultural fiber was added and the melt compounding ended after another 5-10 min. The composition was then extracted from the kneader once still melted. Once cooled, the composition was crushed into powder passing through a 5 mm mesh which was then injected into test bars using an injection molding machine. The same crushed powder was used for MFI measurement. The test bars were used to measure the mechanical properties according to ASTM protocols. The resulting resin exhibited a tensile strength of about 29 MPa, a tensile modulus of about 1800 MPa, an elongation at break of about 44%, a notched Izod impact strength of about 78 J/m and an MFI of about 22g/ 10 min at 190 °C under a 2.16 kg load.

Example 4: A biodegradable resin composition was produced via melt compounding in a twin screw extruder with screw rpm of about 100 and temperature profile of about 130 °C at the feeding zone and about 175 °C at the kneading zone to about 165 °C at the die. About 3770 g PLA, about 250 g talc, about 500 g mica, about 150 g nucleating agent, about 25 g agricultural fiber, about 300 g vegetable-based oil, and about 5 g organic acid were pre-mixed thoroughly and manually prior to feeding into the extruder at a rate of more than 20 kg/h. The composition was extruded, cooled and pelletized followed by injecting into test bars using an injection molding machine. The same pellets were used for MFI measurement. The test bars were used to measure the mechanical properties according to ASTM protocols. The resulting resin exhibited a tensile strength of about 43 MPa, a tensile modulus of about 2370 MPa, an elongation at break of about 15%, a notched Izod impact strength of about 45 J/m and an MFI of about 39 g/10 min at 190 °C under a 2.16 kg load.

Example 5: A biodegradable resin composition was produced via melt compounding in a twin screw extruder with screw rpm of about 100 and temperature profile of about 130 °C at the feeding zone and about 170 °C at the kneading zone to about 165 °C at the die. About 1830 g PHBV, about 1495 g PBAT, about 250 g talc, about 1250 g calcium carbonate, about 25 g agricultural fiber, and about 150 g vegetable-based oil were pre-mixed thoroughly and manually prior to feeding into the extruder at a rate of more than 20 kg/h. The composition was extruded, cooled and pelletized followed by injecting into test bars using an injection molding machine. The same pellets were used for MFI measurement. The test bars were used to measure the mechanical properties according to ASTM protocols. The resulting resin exhibited a tensile strength of about 16 MPa, a tensile modulus of about 840 MPa, an elongation at break of about 3%, a notched Izod impact strength of about 33 J/m and an MFI of about 41 g/10 min at 190 °C under a 2.16 kg load.

While the present invention has been described with reference to a number of preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiments disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A biodegradable resin composition comprising:
i. about 35 to about 90% (w/w) of one or more biodegradable thermoplastic polymers;
ii. about 1 to about 12% (w/w) of one or more plasticizers;
iii. about 3 to about 30% (w/w) of one or more first inorganic fillers;
iv. about 3 to about 25% (w/w) of one or more second inorganic fillers;
V. about 0.01 to about 5% (w/w) of one or more organic acids;
vi. about 0 to about 10% (w/w) of one or more of additives selected from compatibilizers, biomass, impact modifiers, nucleating agents, processing aids, chain extenders, initiators, peroxides, and pigments.

2. The biodegradable resin composition of claim 1, wherein the biodegradable thermoplastic polymer is one or more of biodegradable thermoplastic polyesters selected from the group consisting of polylactic acid (PLA), polyglycolic acid (PGA), polycaprolactone (PCL), polybutylene succinate (PBS), polybutylene succinate adipate (PBSA), polybutylene succinate terephthalate (PBST), polybutylene adipate-co-terephthalate (PBAT), polyhydroxyalkanoates (PHAs); and a combination thereof.

3. The biodegradable resin composition of claim 1, wherein the plasticizer is a plant-based oil of sources selected from the group consisting of vegetables, nuts, grains, seeds, or combinations thereof, wherein the oils comprise corn oil, soybean oil, linseed oil, epoxidized vegetable oil, epoxidized soybean oil, epoxidized linseed oil, epoxidized corn oil, citrate oils, acetyl tributyl citrate (ATBC), triethyl citrate (TEC), acetyl triethyl citrate (ATEC), tributyl citrate (TBC), isosorbide-type oils, natural waxes, glycol, sugar alcohols, glycerol, xylitol, sorbitol, lactitol, mannitol, erythritol, maltitol, isosorbide diester, fatty acid methyl esters (FAME), and combinations thereof.

4. The biodegradable resin composition of claim 1, wherein the first inorganic filler is selected from the group consisting of wollastonite, mica, micro- and nano-clays, non-ionic clays, anionic clays, cationic clays, serpentinite, illite, kaolinite, pyrophyllite, vermiculite, chlorite, talc, sepiolite, aluminum silicate, vermiculites, bentonite, smectites (montmorillonite, nontronite and beidellite, and trioctahedral smectites, such as saponite), swelling micas, and a combination thereof, all in modified or unmodified form.

5. The biodegradable resin composition of claim 1, wherein the second inorganic filler is selected from the group consisting of hydrotalcites, layered double hydroxides, unmodified or modified hydrotalcite, calcium carbonate, glass fiber, silicon dioxide, zirconium oxide, gypsum, and a combination thereof, all in modified or unmodified form.

6. The biodegradable resin composition of claim 1, wherein the organic acid encompasses
i. monocarboxylic acids selected from the group consisting of formic acid, acetic acid, propionic acid, butyric acid, valeric acid, caproic acid, enanthic acid, caprylic acid, pelargonic acid, capric acid; and
ii. dicarboxylic acids selected from the group consisting of oxalic acid, malonic acid, succinic acid, glutaric acid, adipic acid, pimelic acid, suberic acid, azelaic acid, sebacic acid, itaconic acid, fumaric acid, maleic acid; and
iii. tricarboxylic acids selected from the group consisting of citric acid, aconitic acid, isocitric acid, trimesic acid; and
iv. hydroxy acids selected from the group consisting of lactic acid, malic acid, tartaric acid, glycolic acid, 2-hydroxyglutaric acid, mandelic acid, 3-hydroxybutyric acid, salicylic acid, kojic acid, ascorbic acid; and a combination thereof.

7. The biodegradable resin composition of claim 1, wherein the biomass is selected from distillers' grains, vinasse, vinegar residues, cellulose nanocrystals, wood fiber, virgin starch, modified starch including thermoplastic starch, agricultural fiber from straw, stalk, shive, hurd, bast, leaf, seed, fruit, and perennial grass, all in a non-continuous non-woven form including chopped pieces, particulates, dust or flour.

8. The biodegradable blend composition of claim 1, wherein the bio-based carbon content of the composition is up to 100%.

9. The biodegradable resin composition of claim 1, wherein the composition exhibits a 90% biodegradation completion within about 180 days in compost at elevated temperatures.

10. The biodegradable resin composition of claim 1, wherein the composition exhibits an elongation-at-break of more than 10%, preferably more than 30%, more preferably more than 50%.

11. The biodegradable resin composition of claim 1, wherein the composition exhibits a tensile strength of more than 10 MPa, preferably more than 20 MPa, more preferably more than 30 MPa.

12. The biodegradable resin composition of claim 1, wherein the composition exhibits a tensile modulus of more than 1000 MPa, preferably more than 2000 MPa, more preferably more than 3000 MPa.

13. The biodegradable resin composition of claim 1, wherein the composition exhibits a notched Izod impact strength of more than 40 J/m, preferably more than 60 J/m, more preferably more than 100 J/m.

14. The biodegradable resin composition of claim 1, wherein the composition exhibits a melt flow index of more than 20 g/10 min, preferably more than 40 g/10 min, more preferably more than 60 g/10 min at 190 °C under a 2.16 kg load.

15. A method of producing the biodegradable resin composition of claim 1, in which the ingredients are mixed and melt-compounded together in a polymer processing equipment or apparatus selected from the group consisting of a batch mixer, a twin screw extruder or single screw extruder, at elevated temperatures for a time period of several seconds to several minutes.

16. The biodegradable blend composition of claim 1, wherein the composition is used to make articles using conventional polymer processing techniques selected from cast film extrusion, blown film extrusion, profile extrusion, compression molding, thermoforming and injection molding techniques.

17. The biodegradable resin composition of claim 1, wherein the composition is used to make thin-walled articles of various sizes and dimensions via thin-walled injection molding technique.
